(19) United States
(12) Patent Application Publication
(10) Pub. No.: US 2026/0164279 A1
(43) Pub. Date: Jun. 11, 2026

(54) ARTIFICIAL INTELLIGENCE/MACHINE LEARNING (AI/ML) OPERATIONS VIA WIRELESS DEVICE (WD) MEASUREMENT UNCERTAINTY SIGNALING

(71) Applicant: Telefonaktiebolaget LM Ericsson (publ), Stockholm (SE)

(72) Inventors: Henrik RYDÉN, Stockholm (SE); Johan AXNÄS, Solna (SE); Chunhui LI, Yokohama (JP); Andreas NILSSON, Göteberg (SE)

(21) Appl. No.: 19/104,077

(22) PCT Filed: Aug. 18, 2023
(86) PCT No.: PCT/SE2023/050838

§ 371 Date: Feb. 14, 2025

Related U.S. Application Data
(60) Provisional application No. 63/399,298, filed on Aug. 19, 2022.

(51) Int. Cl. H04W 24/10; H04L 41/16

(52) U.S. Cl. CPC H04W 24/10; H04L 41/16

(57) ABSTRACT

A method, system and apparatus for artificial intelligence/machine learning (AI/ML) operations via wireless device (WD) measurement uncertainty signaling are disclosed. According to one aspect, a network node is configured to receive a reference signal strength indicator measurement report, the measurement report including an indication of measurement uncertainties. The network node is configured to train a machine learning model to use the measurement report and the indicated uncertainties to predict at least one best beam.

### TECHNICAL FIELD

The present disclosure relates to wireless communications, and in particular, to artificial intelligence/machine learning (AI/ML) operations via wireless device (WD) measurement uncertainty signaling.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### Measurement Uncertainties for Artificial Intelligence (AI)/Machine Learning (MI)

In 3GPP, there has been consideration of the minimum number of per-subframe measurements needed in L1 filtering to satisfy accuracy requirements since it helps to avoid unnecessary measurements, thereby reducing power consumption. Excerpts from 3GPP Technical Specification (TS) 38.133, v17.5.0, on wireless device measurement requirements are shown in FIGS. 1A and 1B.

The accuracy of the reference signal strength indicator (RSSI) or reference signal received power (RSRP) may depend on several factors, such as the subset size and Cell identification (ID) configurations.

Moreover, the table of FIG. 2 highlights how the uncertainty depends on, e.g., the bandwidth and channel conditions.

### Uncertainties in ML Models

One problem related to AI/ML operation is when a model unknowingly uses information with high uncertainty in the input. One reason for inaccurate uncertainty measures may be due to scenario changes that occur between training and deploying the model. For example, the level of inference measurement accuracy may not match the training data and may cause erroneous use of a trained ML model. In one example below, the measurement accuracy in training data comprises gaussian noise with standard deviation (STD)=1. However, in the inference phase one node may experience higher measurement noise. FIG. 3 shows an example of how the performance may differ from training and inference if the input uncertainty changes. Since the uncertainty in each sample is provided by the training function from the training process, in FIG. 3, the mean squared error (MSE) from training is 1.08, while the actual inference MSE equals 4.08. Note that in case the inference node is not able to retrieve the response variable y, there is no method for the node to accurately estimate the uncertainty of its predictions. The network node will continue to assume a per-sample MSE of 1.08, while it is much higher.

### Discussions in RAN1 #109-e

During the 3GPP meeting RAN1 #109-e, a study of AI/ML-based spatial beam prediction (i.e., study item) was considered, the core idea of which is as follows: Predict the “best” beam (or beams) from a Set A of beams using measurement results from another Set B of beams.

Set A and Set B of beams have not been defined yet and are left for future study; however, the two examples of FIG. 4 illustrate some scenarios that will likely be studied in 3GPP Technical Release 18 (3GPP Rel-18). FIG. 4 shows an example where Set B is a subset of Set A. FIG. 4 illustrates a grid-of-beam type radiation pattern: Each row (resp. column) depicts a certain zenith (resp. azimuth) angle from the antenna array. Set A has 8 beams and Set B has 4 beams (indicated by dark circles).
Set B is a subset of a Set A. For example, Set A is a set of 8 synchronization signal block (SSB)/channel state information reference signal (CSI-RS) beams shown in FIG. 4 (both white and black circles). The wireless device measures Set B (the 4 beams indicated by dark circles). The AI/ML model should predict the best beam (or beams) in Set A using only measurements from Set B;
Set A and Set B correspond to two different sets of beams as shown in FIG. 5. For example, Set A is a set of 30 narrow CSI-RS beams, and Set B is a set of 8 wide SSB beams. The wireless device measures beams in Set B, and the AI/ML model should predict the best beam(s) from Set A.

The spatial beam prediction may be performed in the network node or the wireless device—the study item will cover both scenarios.

The above-mentioned prediction may be based on L1-RSRP estimates for each beam. This study item will, however, also include additional assistance information to help AI/ML model training and inference. For example, that the network node may provide beam-shape assistance information (e.g., transmitter (Tx) beam shapes) to the wireless device. Beam-shape information may enable the wireless device collect and label beam management data (e.g., L1-RSRPs) for the purpose of designing, training, and deploying spatial/temporal beam prediction AI/ML models to wireless devices.

The following list summarizes different types of assistance information discussed in the RAN1 109e meeting:
Tx and/or receiver (Rx) beam shape information (e.g., Tx and/or Rx beam pattern, Tx and/or Rx beam boresight direction (azimuth and zenith angles from the array), 3 dB beamwidth, etc.);
expected Tx and/or Rx beam for the prediction (e.g., expected Tx and/or Rx angle, Tx and/or Rx beam ID for the prediction);
wireless device position information;
wireless device direction information;
Tx beam usage information; and/or
wireless device orientation information.

One issue observed while building a beam prediction AI/ML model is the impact of RSRP measurement errors. Where the erroneous RSRP measurements are used as input/response variable for training the beam prediction model.

To exemplify the impact of RSRP measurement errors, evaluations with varying level of errors have been performed. The errors were modelled as uniformly distributed random offsets in dB domain, independently for each network node beam (in reality, the measurement errors may be more correlated between beams), according to the following: During training: Errors applied to model input as well as targeted model output. During testing, errors are applied to model input but not to targeted model output (ground truth). FIG. 6 illustrates an RSRP difference cumulative distribution function (CDF), for a 4×8 array, 100% outdoor wireless devices, with wireless devices RSRP measurement error 2 dB or 6 dB.

FIG. 6 shows results with a uniformly distributed error of up to +2 dB or #6 dB. The measurement errors may have a significant impact on performance, and need to be considered for realistic evaluations. It may also be necessary to further consider wireless devices measurement accuracy, in particular correlations between errors for different network node beams. Wireless device measurement errors may significantly impact ML beam prediction performance and should be considered in realistic evaluations.

### Polarization Mismatch

Measurements have shown that different polarizations may have different best beams. For example, in non-line-of-sight (NLOS), the strongest beam in one polarization is the weakest beam in the orthogonal polarization, as shown in FIG. 6.

The direction of arrival (DoA) at the network node for a certain wireless device depends on the polarization, as may be seen in FIG. 7, which depicts measured RSRP for three different beams in two polarizations.

Some wireless device manufacturers have claimed that switching the polarization of synchronization signal block (SSB) beams between consecutive SSB bursts will create problems for the automatic gain control (AGC) of the wireless device due to the received power of the two SSBs transmitted for the two orthogonal polarizations differing too much-sometimes more than 10 dB. This indicates how large of a difference in received power there may be between two orthogonal polarizations, and that it may be important to evaluate candidate network node and/or wireless device beams based on measurements of two orthogonal polarizations, if possible.

FIG. 8 depicts that in some areas the DoA (i.e., dashed line with “x” and solid line with circle) differs for the different polarizations

When training a beam prediction model based on RSRP data, the network node may assume an L1-RSRP measurement value according to the 3GPP specified requirements of +−6 dB. Some wireless devices may, to conserve energy, measure on the minimum number of resources required in order to fulfill the +−6 dB requirement threshold, while other wireless devices may not perform this energy saving operation and may derive a much more accurate measurement value. The varying accuracy of estimating the L1-RSRP may lead to unnecessary inaccurate datasets for training the beam prediction model. Since there is no information on the effective measurement accuracy of the retrieved samples, a model may be trained for highly skewed datasets. For example, the model may be trained using high-end receivers with low measurement errors, while inference is conducted for less-capable receivers. This will lead to imperfections in the model prediction performance. Moreover, even if the model is trained for perfect L1-RSRP measurements, the uncertainty of the output will be dependent on the input accuracy of the measurement. A higher input accuracy than the assumed +−6 dB may provide an improved prediction leading to better beam selection and wireless device performance.

Another issue is that higher measurement uncertainty requires more data to be collected to average out such effect. That is, since the network node may only assume the standard requirement of +−6 dB uncertainty in the L1-RSRP, it needs to collect enough data to average out such effect, while in practice the uncertainty may be less than this number and therefore may potentially reduce the data collection overhead.

Another uncertainty of RSRP measurements is due to polarization mis-match. If the network node transmits a single-port single polarized channel state information reference signal (CSI-RS) resource, the measured RSRP may differ up to tens of dB compared to using a two-port dual-polarized CSI-RS resource due to potential polarization mismatch of the channel.

In addition, a wireless device may receive a downlink reference signal (DL-RS) with a wireless device panel with either one polarization active or two orthogonal polarizations active (the wireless device may for example be equipped with some panels that only have a single polarization, or the wireless device may only use one of the polarizations of a dual-polarized panel to save energy). In case the wireless device receives a downlink reference signal (DL-RS) with a single polarization, the measured RSRP will be much more un-reliable compared to using a dual-polarized wireless device panel due to potential mis-match in the channel and/or polarization mis-match between the transmitter and receiver.

### SUMMARY

Some embodiments advantageously provide methods, systems, and apparatuses for artificial intelligence/machine learning (AI/ML) operations via wireless device (WD) measurement uncertainty signaling.

Some embodiments include signaling for a wireless device uncertainty measure of a signal quality value measurement, the signal quality measurement to be used for performing training and inference of an AI/ML beam prediction model. At least one embodiment also includes signaling that indicates that the wireless device is to use the highest possible precision while conducting the signal quality value measurement.

Some embodiments include signaling a WD uncertainty in the signal quality measurement, for example RSRP measurement of SSB/CSI-RS. The measurement uncertainties are used while performing training/inference of an AI/ML model. Some embodiments include requesting the wireless device to use maximum precision in the RSRP measurements to achieve improved prediction models (wireless device will refrain from performing any energy saving operation).

Advantages provided by some embodiments in accordance with the present disclosure may include but are not limited to:
Improved beam prediction by accounting for input measurement uncertainties;
Improved data collection for training beam prediction models by including the uncertainty in the training, for example to scale the sample weight based on the uncertainty;
Improved data collection by only selecting measurements for wireless devices able to accurately determine the RSRP; and/or
I Indicating to the wireless device that it should use maximum precision in the measurements. This may lead to improved models due to less noise in data while training, as well as improved beam predictions due to less measurement errors in the model input.

According to one aspect, a network node configured to communicate with a wireless device, WD, is provided. The network node is configured to: receive a reference signal strength indicator measurement report, the measurement report including an indication of measurement uncertainties; and train a machine learning model to use the measurement report and the indicated measurement uncertainties to predict at least one best beam.

According to this aspect, in some embodiments, the network node is configured to configure the wireless device to use a highest precision during measurements. In some embodiments, the network node is configured to configure the wireless device to use a lowest precision during measurements. In some embodiments, the network node is configured to request a capability of the WD to estimate an uncertainty metric. In some embodiments, the network node is configured to configure the WD with a measurement accuracy of reference signal strength measurements. In some embodiments, the network node is configured to select the machine learning model based at least in part on a measurement uncertainty indicated in the measurement report. In some embodiments, the network node is configured to categorize reference signal strength measurements into training data sets having different uncertainty errors. In some embodiments, the network node is configured to determine a number of samples in a training data set based at least in part on the measurement uncertainties. In some embodiments, the network node is configured to determine a number of samples in a training data set based at least in part on a number of ports used for channel state information reference signal resources. In some embodiments, the network node is configured to determine a number of samples in a training data set based at least in part on a number of polarizations used by the WD to receive downlink reference signals. In some embodiments, the network node is configured to configure the WD to measure a set of K beams to be used to determine a strongest beam with a certain probability.

According to another aspect, a method in a network node configured to communicate with a wireless device, WD, is provided. The method includes: receiving a reference signal strength indicator measurement report, the measurement report including an indication of measurement uncertainties; and training a machine learning model to use the measurement report and the indicated measurement uncertainties to predict at least one best beam.

According to this aspect, in some embodiments, the method includes configuring the wireless device to use a highest precision during measurements. In some embodiments, the method includes configuring the wireless device to use a lowest precision during measurements. In some embodiments, the method includes requesting a capability of the WD to estimate an uncertainty metric. In some embodiments, the method includes configuring the WD with a measurement accuracy of reference signal strength measurements. In some embodiments, the method includes selecting the machine learning model based at least in part on a measurement uncertainty indicated in the measurement report. In some embodiments, the method includes categorizing reference signal strength measurements into training data sets having different uncertainty errors. In some embodiments, the method includes determining a number of samples in a training data set based at least in part on the measurement uncertainties. In some embodiments, the method includes determining a number of samples in a training data set based at least in part on a number of ports used for channel state information reference signal resources. In some embodiments, the method includes determining a number of samples in a training data set based at least in part on a number of polarizations used by the WD to receive downlink reference signals. In some embodiments, the method includes configuring the WD to measure a set of K beams to be used to determine a strongest beam with a a certain probability.

According to another aspect, a wireless device, WD, configured to communicate with a network node, is provided. The WD is configured to: receive an indication of a level of precision for performing reference signal strength measurements; estimate measurement uncertainties for the reference signal strength measurements; and transmit a measurement report that includes the estimated measurement uncertainties.

According to this aspect, in some embodiments, the measurement report includes at least one of a number of ports and a number of polarizations for receiving a reference signal. In some embodiments, the WD is configured by the network node to use a highest precision during measurements. In some embodiments, the WD is configured by the network node to use a lowest precision during measurements. In some embodiments, the WD is configure by the network node to perform the reference signal strength measurements with a specified level of accuracy.

According to yet another aspect, a method in a wireless device, WD, configured to communicate with a network node is provided. The method includes: receiving an indication of a level of precision for performing reference signal strength measurements; estimating measurement uncertainties for the reference signal strength measurements; and transmitting a measurement report that includes the estimated measurement uncertainties.

According to this aspect, in some embodiments, the measurement report includes at least one of a number of ports and a number of polarizations for receiving a reference signal. In some embodiments, the method includes using a highest precision during measurements according to a configuration from the network node. In some embodiments, the method includes using a lowest precision during measurements according to a configuration from the network node. In some embodiments, the method includes performing the reference signal strength measurements with a level of accuracy specified by the network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIGS. 1A and 1B illustrate data tables relevant to RSRP metrics;

FIG. 2 is a data table relevant to measuring uncertainty;

FIG. 3 is a graphical representation of performance;

FIG. 4 is a representative diagram of a grid-of-beam type radiation pattern;

FIG. 5. is a representative diagram of a grid-of-beam type radiation pattern;

FIG. 6 is a graphical representation of an RSRP difference cumulative distribution function;

FIG. 7 is a graphical representation of RSRP measurements;

FIG. 8 is a graphical representation of DoAs;

FIG. 9 is a schematic diagram of an example network architecture illustrating a communication system connected via an intermediate network to a host computer according to the principles in the present disclosure;

FIG. 10 is a block diagram of a host computer communicating via a network node with a wireless device over an at least partially wireless connection according to some embodiments of the present disclosure;

FIG. 11 is a flowchart illustrating example methods implemented in a communication system including a host computer, a network node and a wireless device for executing a client application at a wireless device according to some embodiments of the present disclosure;

FIG. 12 is a flowchart illustrating example methods implemented in a communication system including a host computer, a network node and a wireless device for receiving user data at a wireless device according to some embodiments of the present disclosure;

FIG. 13 is a flowchart illustrating example methods implemented in a communication system including a host computer, a network node and a wireless device for receiving user data from the wireless device at a host computer according to some embodiments of the present disclosure;

FIG. 14 is a flowchart illustrating example methods implemented in a communication system including a host computer, a network node and a wireless device for receiving user data at a host computer according to some embodiments of the present disclosure;

FIG. 15 is a flowchart of an example process in a network node for machine learning model based operations according to some embodiments of the present disclosure;

FIG. 16 is a flowchart of an example process in a wireless device for machine learning model based operations according to some embodiments of the present disclosure;

FIG. 17 is a flowchart of an example process in a network node for machine learning model based operations according to some embodiments of the present disclosure;

FIG. 18 is a flowchart of an example process in a wireless device for machine learning model based operations according to some embodiments of the present disclosure;

FIG. 19 is a graphical representation of example RSRP differences according to some embodiments of the present disclosure; and

FIG. 20 is a graphical representation of example RSRP differences according to some embodiments of the present disclosure.

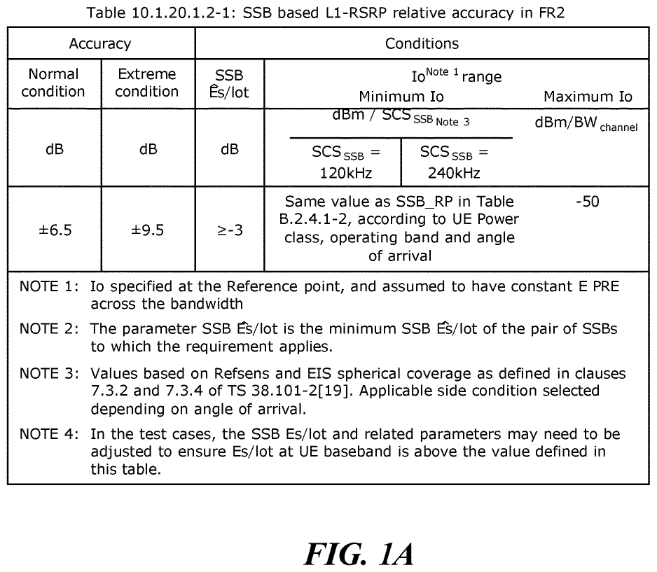

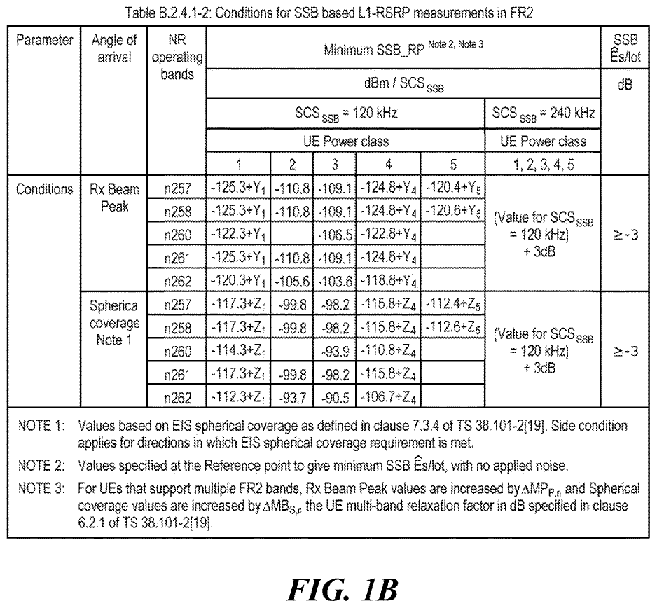

### DETAILED DESCRIPTION

Before describing in detail example embodiments, it is noted that the embodiments reside primarily in combinations of apparatus components and processing steps related to machine learning model based operations. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for machine learning model based operations.

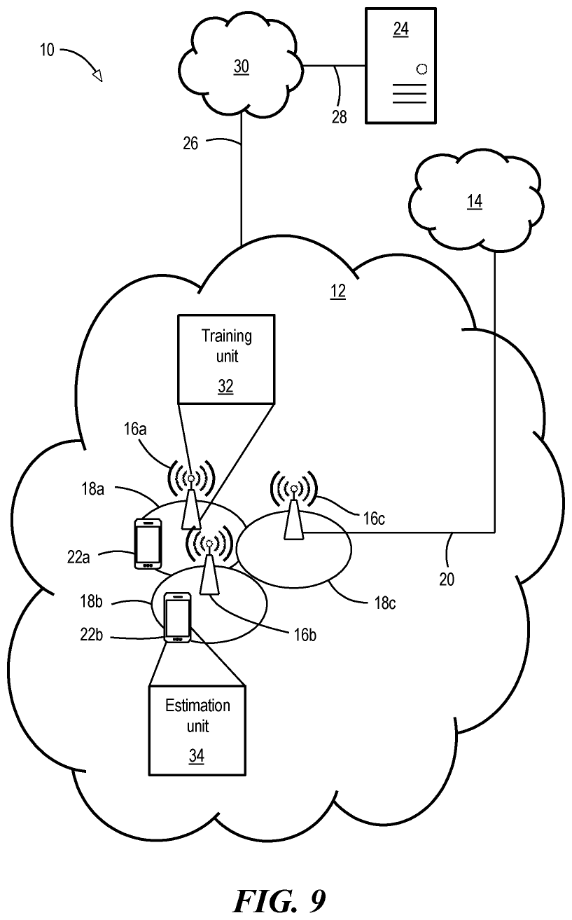

Returning now to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 9 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a training unit 32 which is configured to perform one or more network node 16 functions described herein, including functions related to machine learning model based operations. A wireless device 22 is configured to include a estimation unit 34 which is configured to perform one or more network node 16 functions described herein, including functions related to machine learning model based operations.

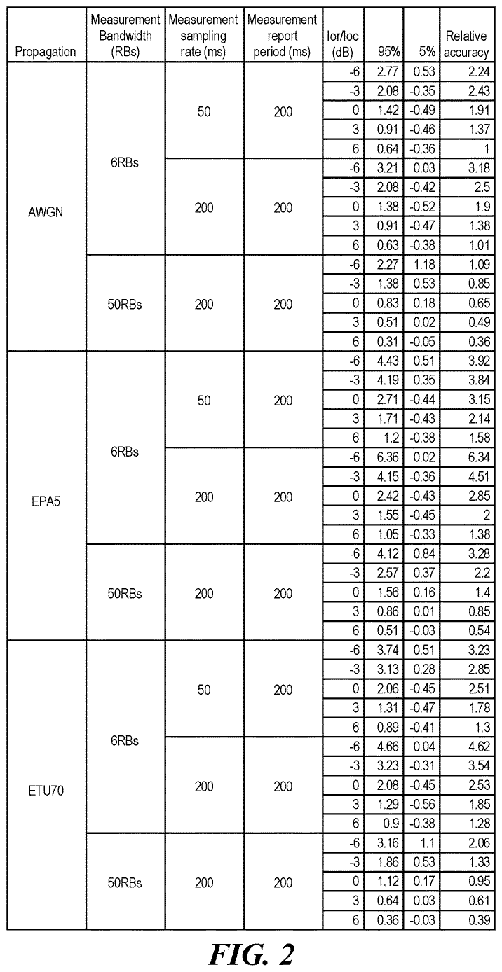

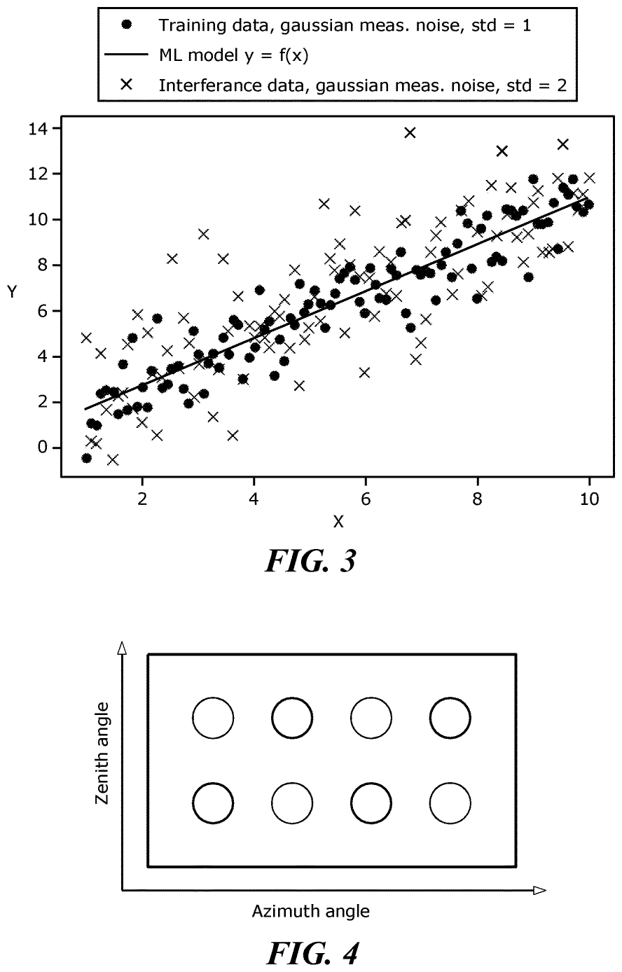

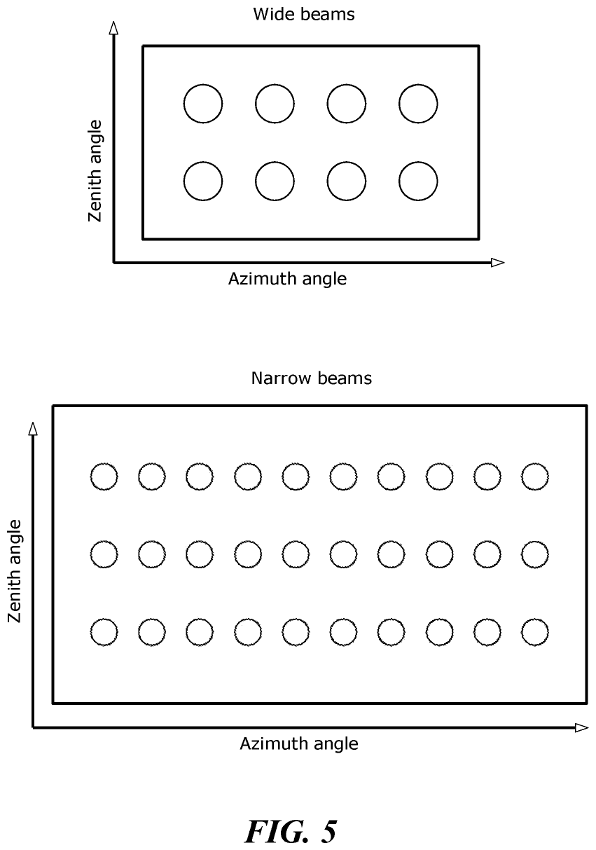

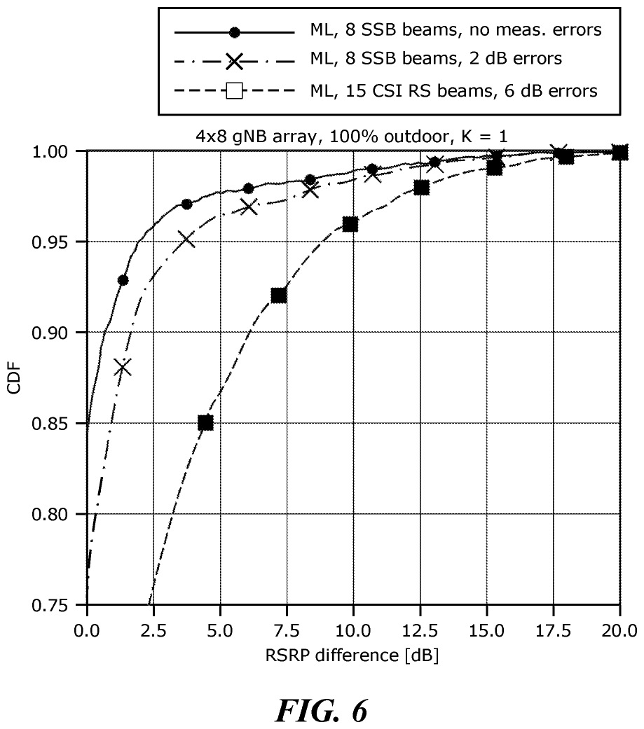

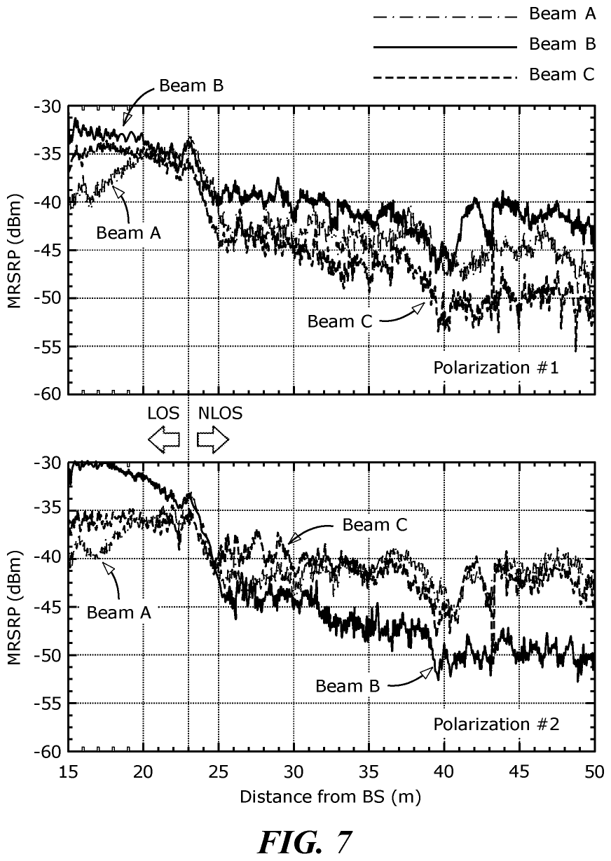

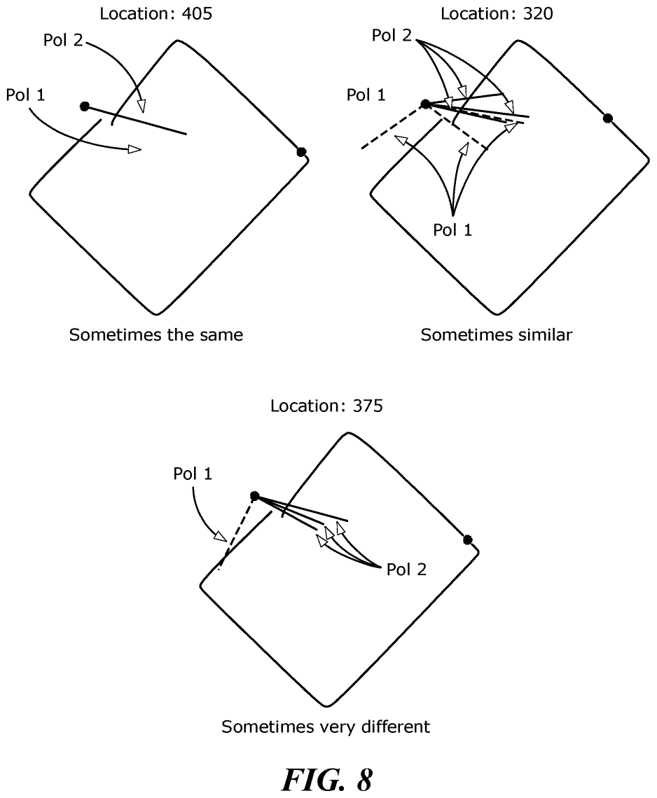

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The processing circuitry 42 of the host computer 24 may include a control unit 54 configured to enable the service provider to observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include training unit 32 configured to perform one or more network node 16 functions described herein, including functions related to machine learning model based operations.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an estimation unit 34 configured to perform one or more wireless device 22 functions described herein, including functions related to machine learning model based operations.

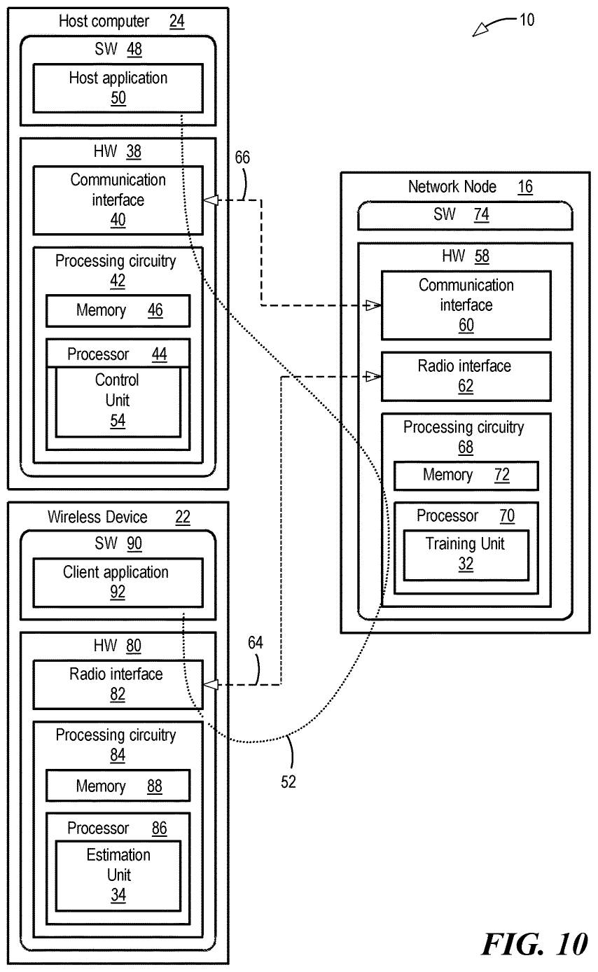

In some embodiments, the inner workings of the network node 16, WD 22, and host computer 24 may be as shown in FIG. 10 and independently, the surrounding network topology may be that of FIG. 9.

In FIG. 10, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

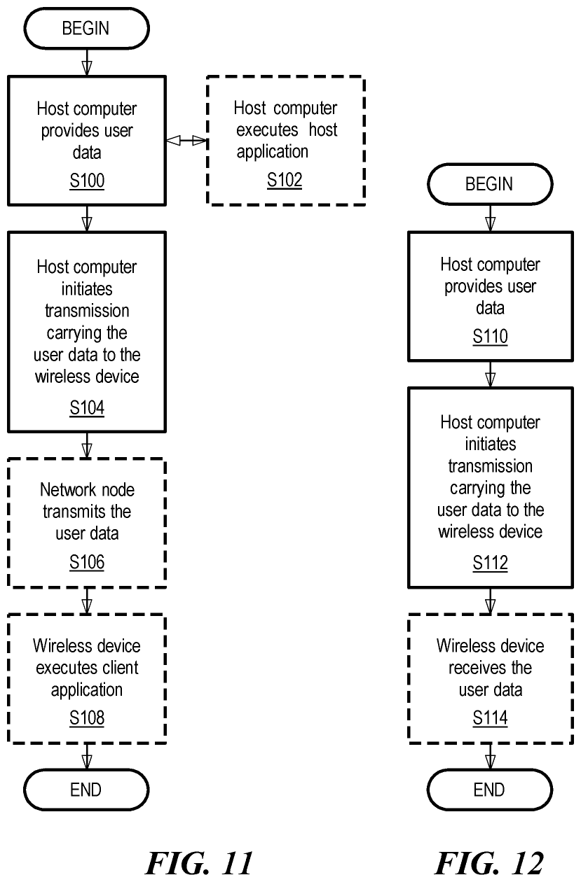

Although FIGS. 9 and 10 show various “units” such as training unit 32, and estimation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry. FIG. 11 is a flowchart illustrating an example method implemented in a communication system, such as, for example, the communication system of FIGS. 9 and 10, in accordance with one embodiment. The communication system may include a host computer 24, a network node 16 and a WD 22, which may be those described with reference to FIG. 10. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 12 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

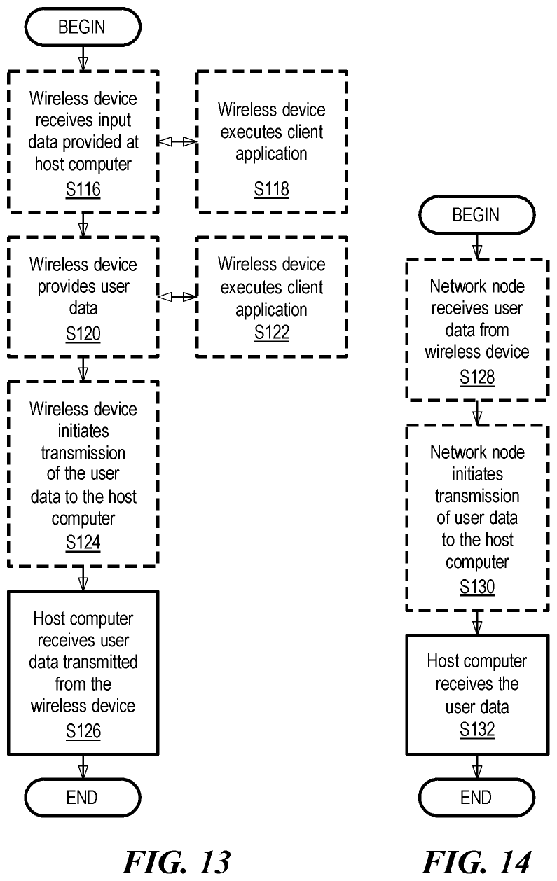

FIG. 13 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 14 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

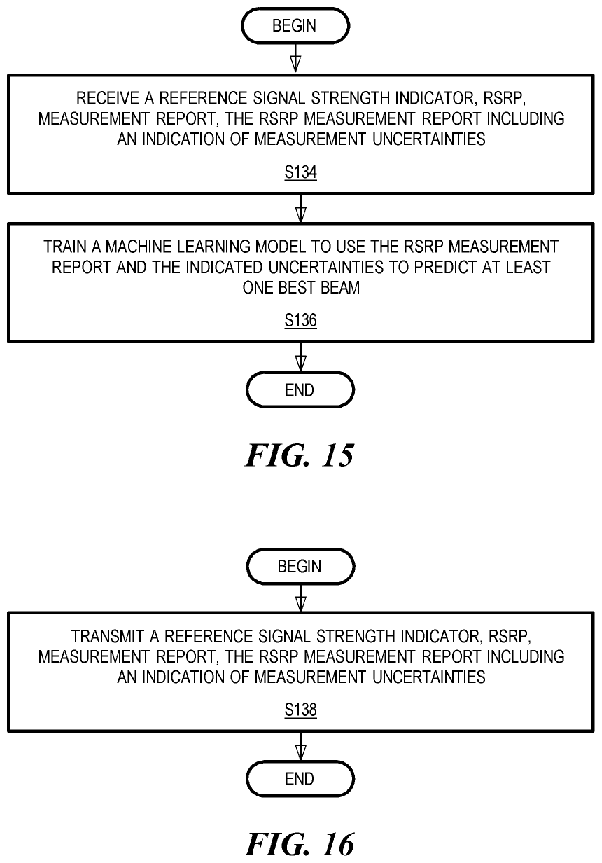

FIG. 15 is a flowchart of an example process in a network node 16 according to some embodiments of the present disclosure. One or more blocks described herein may be performed by one or more elements of network node 16 such as by one or more of processing circuitry 68 (including the training unit 32), processor 70, radio interface 62 and/or communication interface 60. Network node 16 is configured to receive a RSRP measurement report, the RSRP measurement report including an indication of measurement uncertainties (Block S134). In one or more embodiments, RSRP may be replaced by one or more other RS metrics. The network node 16 is also configured to train a machine learning module to use the RSRP measurement report and the indicated uncertainties to predict at least one best beam (Block S136). At least one best beam may correspond to a beam having at least one higher measurable characteristic than the remaining beams.

In some embodiments, the training of the machine learning module includes using at least one of the number of polarizations used by the wireless device 22 to receive a DL-RS and a number of ports used for the CSI-RS. In some embodiments, the network node 16 is configured to configure the wireless device 22 to generate and transmit the RSRP measurement report.

FIG. 16 is a flowchart of an example process in a wireless device 22 according to some embodiments of the present disclosure. One or more blocks described herein may be performed by one or more elements of wireless device 22 such as by one or more of processing circuitry 84 (including the estimation unit 34), processor 86, radio interface 82 and/or communication interface 60. Wireless device 22 is configured to transmit a reference signal strength indicator, RSRP, measurement report, the RSRP measurement report including an indication of measurement uncertainties (Block 136).

In some embodiments, the wireless device 22 is configured to determine and transmit with the RSRP measurement report a correlation in uncertainty between two RSRP measurements. In some embodiments, the wireless device 22 is configured to transmit an indication of its capability to assess measurement uncertainties.

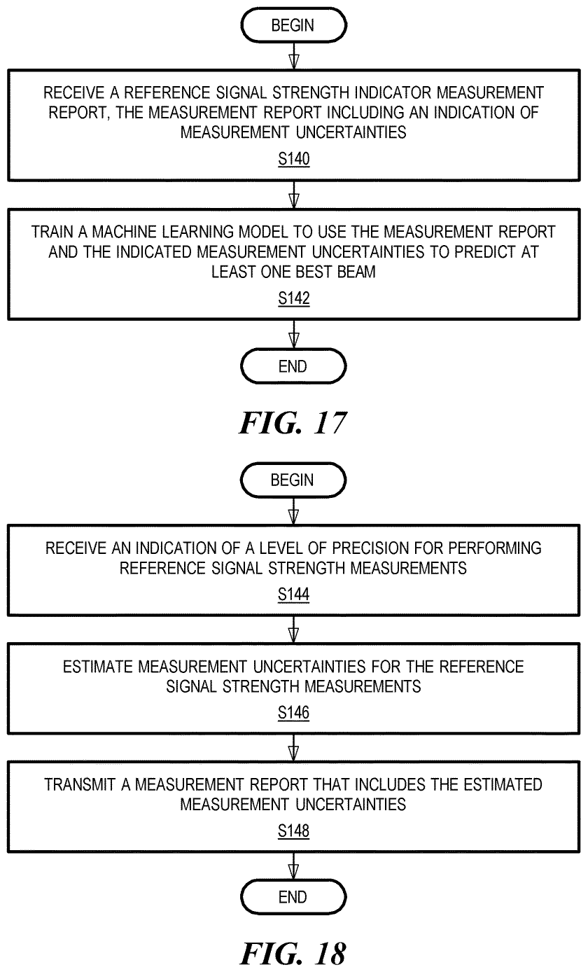

FIG. 17 is a flowchart of an example process in a network node 16 according to some embodiments of the present disclosure. One or more blocks described herein may be performed by one or more elements of network node 16 such as by one or more of processing circuitry 68 (including the training unit 32), processor 70, radio interface 62 and/or communication interface 60. Network node 16 is configured to receive a reference signal strength indicator measurement report, the measurement report including an indication of measurement uncertainties (Block S140). The process includes training a machine learning model to use the measurement report and the indicated measurement uncertainties to predict at least one best beam (Block S142). In some embodiments, the method includes configuring the wireless device to use a highest precision during measurements. In some embodiments, the method includes configuring the wireless device to use a lowest precision during measurements. In some embodiments, the method includes requesting a capability of the WD to estimate an uncertainty metric. In some embodiments, the method includes configuring the WD with a measurement accuracy of reference signal strength measurements. In some embodiments, the method includes selecting the machine learning model based at least in part on a measurement uncertainty indicated in the measurement report. In some embodiments, the method includes categorizing reference signal strength measurements into training data sets having different uncertainty errors. In some embodiments, the method includes determining a number of samples in a training data set based at least in part on the measurement uncertainties. In some embodiments, the method includes determining a number of samples in a training data set based at least in part on a number of ports used for channel state information reference signal resources. In some embodiments, the method includes determining a number of samples in a training data set based at least in part on a number of polarizations used by the WD to receive downlink reference signals. In some embodiments, the method includes configuring the WD to measure a set of K beams to be used to determine a strongest beam with a a certain probability. FIG. 18 is a flowchart of an example process in a wireless device 22 according to some embodiments of the present disclosure. One or more blocks described herein may be performed by one or more elements of wireless device 22 such as by one or more of processing circuitry 84 (including the estimation unit 34), processor 86, radio interface 82 and/or communication interface 60. Wireless device 22 is configured to receive an indication of a level of precision for performing reference signal strength measurements (Block S144). The process includes estimating measurement uncertainties for the reference signal strength measurements (Block S146). The process also includes transmitting a measurement report that includes the estimated measurement uncertainties (Block S148).

In some embodiments, the measurement report includes at least one of a number of ports and a number of polarizations for receiving a reference signal. In some embodiments, the method includes using a highest precision during measurements according to a configuration from the network node. In some embodiments, the method includes using a lowest precision during measurements according to a configuration from the network node. In some embodiments, the method includes performing the reference signal strength measurements with a level of accuracy specified by the network node.

Having described the general process flow of arrangements of the disclosure and having provided examples of hardware and software arrangements for implementing the processes and functions of the disclosure, the sections below provide details and examples of arrangements for machine learning model based operations. One or more wireless device 22 functions described below may be performed by one or more of processing circuitry 84, processor 86, estimation unit 34, etc. One or more network node 16 functions described below may be performed by one or more of processing circuitry 68, processor 70, training unit 32, etc.

Some embodiments provide for steps performed in a network node 16 and/or a wireless device 22. In some embodiments, steps performed by a network node 16 may include one or more of the following:
100. Request capabilities for reporting measurement uncertainties;
101. Configure wireless device 22 to:
   a. include measurement uncertainties in the measurement report;
   b. use maximum possible precision during measurements (refrain from performing energy saving operations);
102. Receive measurements with associated uncertainties;
103. Use measurement uncertainties in AI/ML model operations (model training/inference).

In some embodiments, steps performed by a wireless device 22 include:
200. Indicate capabilities to assess measurement uncertainties;
201. Estimate uncertainty related to a certain measurement; and/or
202. Signal uncertainties associated to a certain measurement

### Capability Request

The network node 16 may request the capabilities of the WD 22 in estimating and providing an uncertainty metric. In some embodiments, the network node 16 provides the wireless device 22 with a required accuracy of the RSRP measurements. The wireless device 22 can, for example, improve the accuracy by measuring over a wider bandwidth, measure with two polarization of the wireless device 22 panel or for more orthogonal frequency division multiplexing (OFDM) symbols. Note that wireless device 22 may reduce the number of resources spent to retrieve accurate RSRP estimates to save energy as long as it fulfills the 6 dB requirement.

### Wireless Device 22 Configuration of Maximum Measurement Precision

The network node 16 may indicate to the wireless device 22 that the RSRP measurements are part of an AI/ML operation, and that the wireless device 22 should use maximum possible precision for such measurements. Otherwise, the wireless device 22 may conduct energy-saving operations that would reduce the precision to the standardized +−6 dB requirement. The flag may be part of an radio resource control (RRC) measurement configuration, for example.

Examples of energy saving operations include the wireless device 22 measuring on a subset of all possible time-frequency resources when estimating the RSRP value. The wireless device 22 may involve only a subset of the available antennas in the measurement operation. Alternatively, the wireless device 22 may only use one out of two possible polarizations associated with a wireless device 22 panel.

### Uncertainty Reporting

### Estimating Measurement Uncertainty

The wireless device 22 may estimate the uncertainty for the RSRP measurements by, for example:
Hardware test for the specific network configuration (bandwidth, subcarrier spacing, frequency, etc.) and/or using a model of the RSRP accuracy;
Using a network simulator to estimate the RSRP measurement error for a certain configuration; and/or
Divide the measurements of RSRP into different subsets and estimate the RSRP for each subset. Then, the accuracy may include the variance calculated based on the collection of subsets. Example of methods to split them into subsets may for example include of one orthogonal frequency division multiplexed (OFDM) symbol per subset, or one resource block per subset.

### Reporting

### Reporting a One-Time Value

The wireless device 22 may indicate its uncertainty measure value for all L1-RSRP measurements.

Reporting a Value that Holds Until Further Notice

In some embodiments, the wireless device 22 may indicate its uncertainty measure value for all L1-RSRP measurements until a new indication is provided, or some other event (e.g., a change of cell and/or carrier) takes place that resets the uncertainty measurement to a default value.

### Reporting a Per Measurement Uncertainty Value

The report may include, for a specific measurement, e.g.:
Uncertainty range, e.g.:
   +−2 dB with a 90% confidence;
   +−3 dB with 99% confidence;
Probability of uncertainty within 1 dB (e.g., 90% probability); and
Number of used polarizations for the wireless device 22 panel receiving the downlink reference signal (DL-RS).

In some embodiments, the report may describe the correlation in uncertainty between two measurements.
Correlated RSRP measurements, for example the dependency of two L1-RSRP measurements

High correlation between measurements may facilitate best-beam prediction. For example, in the case where the error is identical in all measurements (e.g., all measurements exactly 1 dB too high), the measurement error may not need to affect prediction at all if prediction is based only (or primarily) on relative powers on different beams, which may be a typical ML model implementation. Knowledge of the correlation in uncertainty between two measurements may be used as follows:
(1) During the inference phase, the network node 16 may proactively switch to the model trained with different uncertainty error. For example, if the correlation in uncertainty between two measurements is high, then, during inference, the network node 16 may continue to use the selected model based on the latest wireless device 22 reported uncertainty. If the correlation in uncertainty between two measurements is low, then the network node 16 may switch to another model trained with a different uncertainty; and/or
(2) During the data collection phase, the correlation in uncertainty between two measurements may further help the network to categorize the data into different training datasets (i.e., training datasets with different uncertainty error).

In a sub-embodiment, to reduce reporting overhead, the measurements may be divided into different groups (e.g., using a binary map, or some other method) and the uncertainty specified per group, not per individual measurement.

### Using Measurement Uncertainties for AI/ML Model Training

### Reduce the Amount of Collected Data

The network node 16 may include the wireless device 22 reported uncertainty when training the model as a basis for deciding the number of samples needed in the training dataset. There are two inherently different sources of uncertainty, often referred to as aleatoric and epistemic uncertainty. Aleatoric (or statistical) uncertainty refers to the noise in the data, meaning the probabilistic variability of the output due to inherent random effects. It is irreducible, which means that it cannot be reduced by providing more training data or choosing a different AI/ML model or algorithm. By contrast, epistemic (or systematic) uncertainty comes from limited data and knowledge about the system and underlying processes and phenomena. Regarding AI/ML, it may refer to the lack of knowledge about the perfect model, e.g., best model parameters, typically due to inappropriate or insufficient training data. This part of the total uncertainty is in principle reducible, for example by providing more data.

The systematic uncertainty may be, for example, due to the measurement errors, and prior to training a model, a network node 16 may need to receive, for example, N samples for accuracy of ±2 dB, and 2N samples for accuracy of ±4 dB.

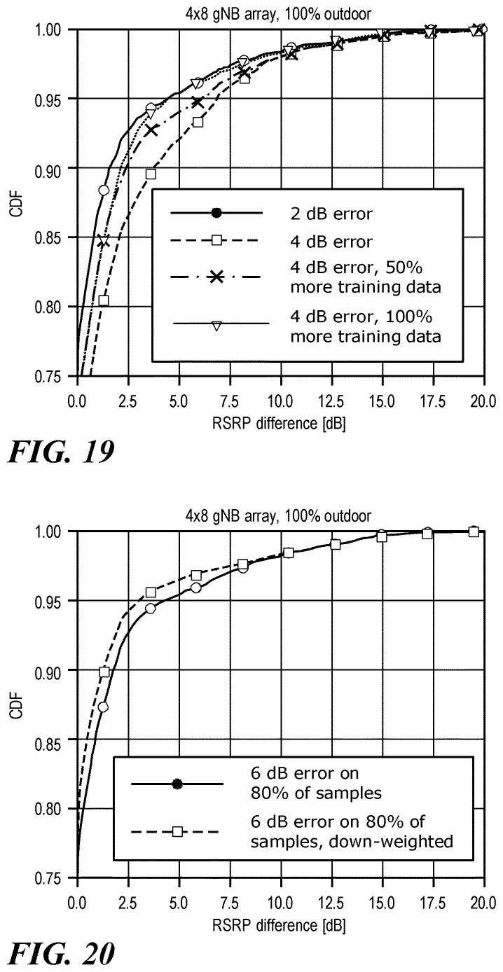

Example simulation results are shown in FIG. 17. FIG. 19 shows simulations run for two different settings of RSRP measurement inaccuracy (uncertainty) during training (uniformly randomly distributed within either ±2 dB or ±4 dB), and for different amounts of training data. For inference (testing), no RSRP measurement inaccuracy were used. The curves shown are cumulative density functions (CDFs) over all wireless devices 22 in the inference (test) set, with the x axis indicating the difference between the RSRP that would have been achieved for a wireless device 22 if the optimal beam had been used and the RSRP that was actually achieved using the beam predicted by the neural network (i.e. the smaller the difference, the better). As may be seen from FIG. 17, to reach similar RSRP performance with ±4 dB measurement inaccuracy as with ±2 dB measurement inaccuracy, about 100% more training samples may be needed in the former case.

In some embodiments, the network node 16 includes the number of ports used for the CSI-RS resources when training the model, as a basis for deciding the number of samples needed in the training dataset. Since, using two-port CSI-RS resources transmitted with two orthogonal polarization may give more reliable RSRP measurements, the number of samples may be reduced when using two-port CSI-RS resources. In some embodiments, in case the wireless device 22 only supports single-port CSI-RS resources for beam management procedures (note that two-port CI-RS resource for beam management is a wireless device 22 capability that may not be supported by existing commercial wireless devices 22), the network node 16 transmits two single-port CSI-RS resources for each network node 16 beam. The first single-port CSI-RS resource is transmitted over a first polarization, and the second CIS-RS resource is transmitted over the second polarization. In this way, the network node 16 may collect data for both polarizations without using a two-port CIS-RS resource, and thereby improve the reliability of the trained AI/ML model.

In some embodiments, the network node 16 includes the number of polarizations used by the wireless device 22 to receive a DL-RS when training the model as a basis for deciding the number of samples needed in the training dataset. If the wireless device 22 uses two polarizations instead of a single polarization when receiving a DL-RS, the reliability of the measurement may be much higher, and fewer samples may be needed to train the model. In some embodiments, the wireless device 22 is configured to include in a beam report, the number of polarizations/RX ports the wireless device 22 panel used when receiving a DL-RS. In some embodiments, the wireless device 22 reports a wireless device 22 panel index (e.g., the “wireless device 22 capability value set” introduced in NR 3GPP Rel-17) for each reported DL-RS index in the beam report, and where the number of polarizations/RX ports has been previously indicated (e.g., during wireless device 22 capability signaling) for each wireless device 22 panel index (wireless device 22 capability value set).

### Sample Weights

The sample weights may be based on the wireless device-reported measurement uncertainty, where samples stemming from high-end wireless devices 22 may have higher weights (more important) than weights from low-end wireless devices 22. The sample weight may impact the model training, for example, by including the sample weight in the optimization function. A typical optimization is to minimize the mean squared error of the model output and the true value, i.e.:

$$M S E = \frac{1}{N} \sum {( f ( x ) - {y}_{true} )}^{2}$$

The sample weight may be included by adding an additional sample weight term:

$$M S E = \frac{1}{N} {\sum }_{s} {{w}_{s} ( f ( {x}_{s} ) - {y}_{{true}_{s}} )}^{2}$$

where the MSE is calculated for all stored N samples.

The gain from weighting is illustrated in FIG. 20. During training, 80% of the samples were given an RSRP measurement inaccuracy (uncertainty) of up to ±6 dB (uniformly distributed), while 20% of the samples had no inaccuracy. During inference/testing, there was no RSRP measurement inaccuracy. FIG. 20 shows performance for a baseline case where no sample weighting is performed, and a case where the samples with inaccuracy are given weight w_s=0.1, while the other samples are given weight w_s=1.0. As may be seen, weighting improved performance.

### Training a Generic Model for Different Uncertainty Errors

The network node 16 may process the training data based on the wireless-device-reported measurement uncertainty by mixing the training data with weighting factors. Deciding the weighting factor may depend on the network node implementation. An example is in a case in which six different uncertainty errors are considered, i.e., {±2 Db, ±4 Db, ±6 Db}. Then, the network node 16 may set different weighting factors to each uncertainty, i.e., w_1=0.5, w_2=0.3, w_3=0.2 for data with ±2 Db, ±4 Db, ±6 Db uncertainty, respectively. So, after the model training, the network node 16 may use this model to perform the beam prediction.

### Training Different Models for Different Uncertainty Errors

The network node 16 may collect and categorize the training data based on the wireless-device-reported measurement uncertainty. For example, three different uncertainty errors may be considered, i.e., {±2 dB, ±4 dB, ±6 dB}. Then, the network node 16 may train three different models (e.g., AI/MI models) corresponding to each uncertainty. So, after the model training, the network node 16 may apply or switch to the model with ±2 dB if wireless device 22 reports ±2 dB uncertainty error.

In some embodiments, the more polarizations that have been used at the network node 16 side and the wireless device 22 side for a DL-RS beam report, the more reliable the measurements are assumed to be, and the higher sample weights the measurements will get. For example, if a DL-RS beam report is associated with a single-port CSI-RS resource which is received with a wireless device 22 panel using a single polarization (i.e., one RX port), the sample weight will be lower compared to the sample weight for a DL-RS beam report associated with a two-port CSI-RS resource which is received with a wireless device 22 panel using two polarizations (i.e., two RX ports).

### Using Measurement Uncertainties for AI/ML Model Inference

### Including Uncertainty in Inference Step

The uncertainty may be used to perform multiple inference operations by sampling according to the provided measurement uncertainty. For example, suppose certain measurement sample x has an associated measurement uncertainty of a uniformly distributed error of up to +−6 dB. The network node 16 may draw N different values from the uniform distribution and add to the original sample x. Next, the network node 16 provides a distribution of potential outputs, that may be used to estimate the output uncertainty, given the input uncertainty.

In some embodiments, a method for including the uncertainty in the model inference step may be performed by inputting the measurement uncertainty directly while training and performing the inference of the model.

### Network Node Configuration Based on AI/ML Model Output

Based on the AI/ML model output, the network node 16 may, for example, configure the wireless device 22 to measure on the Top-K beams that are needed to find the strongest wireless device 22 beam with a certain probability. In some embodiments, “strongest” may refer to strongest in terms of highest signal quality, e.g., in terms of RSRP or SINR. Note that in case of high uncertainty on the RSRP input measurements, the number K of beams is typically higher.

The network node 16 may, in case of high uncertainty on the RSRP input measurements, configure more frequent measurements and/or fallback to legacy beam management procedures.

Some embodiments may include one or more of the following:

Embodiment A1. A network node configured to communicate with a wireless device (WD), the network node configured to, and/or comprising a radio interface and/or comprising processing circuitry configured to:
receive a reference signal strength indicator, RSRP, measurement report, the RSRP measurement report including an indication of measurement uncertainties; and
train a machine learning model to use the RSRP measurement report and the indicated uncertainties to predict at least one best beam.

Embodiment A2. The network node of Embodiment A1, wherein the training of the machine learning module includes using at least one of the number of polarizations used by the wireless device to receive a downlink reference signal, DL-RS, and a number of ports used for the channel state information reference signal, CSI-RS.

Embodiment A3. The network node of Embodiment A1, wherein the processing circuitry is further configured to configure the wireless device to generate and transmit the RSRP measurement report.

Embodiment B1. A method implemented in a network node, the method comprising:
receiving a reference signal strength indicator, RSRP, measurement report, the RSRP measurement report including measurement uncertainties; and
training a machine learning module to use the RSRP measurement report and the indicated uncertainties to predict at least one best beam.

Embodiment B2. The method of Embodiment B1, wherein the training of the machine learning module includes using at least one of the number of polarizations used by the wireless device to receive a downlink reference signal, DL-RS, and a number of ports used for the channel state information reference signal, CSI-RS.

Embodiment B3. The method of Embodiment B1, further comprising configuring the wireless device to produce and transmit the RSRP measurement report.

Embodiment C1. A wireless device (WD) configured to communicate with a network node, the WD configured to, and/or comprising a radio interface and/or processing circuitry configured to:
transmit a reference signal strength indicator, RSRP, measurement report, the RSRP measurement report including an indication of measurement uncertainties for use by the network node for machine learning model based operations.

Embodiment C2. The WD of Embodiment C1, wherein the processing circuitry is further configured to determine and transmit with the RSRP measurement report a correlation in uncertainty between two RSRP measurements.

Embodiment C3. The WD of Embodiment C1, wherein the processing circuitry is further configured to transmit an indication of its capability to assess measurement uncertainties.

Embodiment D1. A method implemented in a wireless device (WD), the method comprising transmitting a reference signal strength indicator, RSRP, measurement report, the RSRP measurement report including an indication of measurement uncertainties.

Embodiment D2. The method of Embodiment D1, further comprising determining and transmitting with the RSRP measurement report a correlation in uncertainty between two RSRP measurements

Embodiment D3. The method of Embodiment D1, further comprising transmitting an indication of its capability to assess measurement uncertainties.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3rd Generation Partnership Project |
| 5G | Fifth Generation |
| ACK | Acknowledgement |
| AI | Artificial Intelligence |
| AoA | Angle of Arrival |
| CORESET | Control Resource Set |
| CSI | Channel State Information |
| CSI-RS | CSI Reference Signal |
| DCI | Downlink Control Information |
| DoA | Direction of Arrival |
| DL | Downlink |
| DMRS | Downlink Demodulation Reference Signals |
| FDD | Frequency-Division Duplex |
| FR2 | Frequency Range 2 |
| HARQ | Hybrid Automatic Repeat Request |
| ID | identity |
| gNB | gNodeB |
| MAC | Medium Access Control |
| MAC-CE | MAC Control Element |
| ML | Machine Learning |
| NR | New Radio |
| NW | Network |
| OFDM | Orthogonal Frequency Division Multiplexing |
| PBCH | Physical Broadcast Channel |
| PCI | Physical Cell Identity |
| PDCCH | Physical Downlink Control Channel |
| PDSCH | Physical Downlink Shared Channel |
| PRB | Physical Resource Block |
| QCL | Quasi co-located |
| RL | Reinforcement Learning |
| RS | Reference Signal |
| Rx | Receiver |
| RB | Resource Block |
| RRC | Radio Resource Control |
| RSRP | Reference Signal Strength Indicator |
| RSRQ | Reference Signal Received Quality |
| RSSI | Received Signal Strength Indicator |
| SCS | Subcarrier Spacing |
| SINR | Signal to Interference plus Noise Ratio |
| SSB | Synchronization Signal Block |
| TB | Transport Block |
| TDD | Time-Division Duplex |
| TCI | Transmission configuration indication |
| TRP | Transmission/Reception Point |
| Tx | Transmitter |
| UE | User Equipment |
| UL | Uplink |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node configured to:
receive a reference signal strength indicator measurement report, the measurement report including an indication of measurement uncertainties; and
train a machine learning model to use the measurement report and the indicated measurement uncertainties to predict at least one best beam.

2. (canceled)

3. (canceled)

4. The network node of claim 1, wherein the network node is configured to request a capability of the WD to estimate an uncertainty metric.

5. (canceled)

6. The network node of claim 1, wherein the network node is configured to select the machine learning model based at least in part on a measurement uncertainty indicated in the measurement report.

7.-11. (canceled)

12. A method in a network node configured to communicate with a wireless device, WD, the method comprising:
receiving a reference signal strength indicator measurement report, the measurement report including an indication of measurement uncertainties; and
training a machine learning model to use the measurement report and the indicated measurement uncertainties to predict at least one best beam.

13. The method of claim 12, further comprising configuring the wireless device to use a highest precision during measurements.

14. The method of claim 12, further comprising configuring the wireless device to use a lowest precision during measurements.

15. The method of claim 12, further comprising requesting a capability of the WD to estimate an uncertainty metric.

16. The method of claim 12, further comprising configuring the WD with a measurement accuracy of reference signal strength measurements.

17. The method of claim 12, further comprising selecting the machine learning model based at least in part on a measurement uncertainty indicated in the measurement report.

18. The method of claim 12, further comprising categorizing reference signal strength measurements into training data sets having different uncertainty errors.

19. The method of claim 12, further comprising determining a number of samples in a training data set based at least in part on the measurement uncertainties.

20. The method of claim 12, further comprising determining a number of samples in a training data set based at least in part on a number of ports used for channel state information reference signal resources.

21. The method of claim 12, further comprising determining a number of samples in a training data set based at least in part on a number of polarizations used by the WD to receive downlink reference signals.

22. The method of claim 21, further comprising configuring the WD to measure a set of K beams to be used to determine a strongest beam with a certain probability.

23. A wireless device, WD, configured to communicate with a network node, the WD configured to:
receive an indication of a level of precision for performing reference signal strength measurements;
estimate measurement uncertainties for the reference signal strength measurements; and
transmit a measurement report that includes the estimated measurement uncertainties.

24.-27. (canceled)

28. A method in a wireless device, WD, configured to communicate with a network node, the method comprising:
receiving an indication of a level of precision for performing reference signal strength measurements;
estimating measurement uncertainties for the reference signal strength measurements; and
transmitting a measurement report that includes the estimated measurement uncertainties.

29. The method of claim 28, wherein the measurement report includes at least one of a number of ports and a number of polarizations for receiving a reference signal.

30. The method of claim 28, further comprising using a highest precision during measurements according to a configuration from the network node.

31. The method of claim 28, further comprising using a lowest precision during measurements according to a configuration from the network node.

32. The method of claim 28, further comprising performing the reference signal strength measurements with a level of accuracy specified by the network node.
